(19) United States
(12) Patent Application Publication
(10) Pub. No.: US 2026/0089674 A1
(43) Pub. Date: Mar. 26, 2026

(54) METHODS OF MOBILE TERMINATED LOCATION REQUEST FOR LOCATION OF WTRU OUT OF COVERAGE

(71) Applicant: InterDigital Patent Holdings, Inc., Wilmington, DE (US)

(72) Inventors: Jung Je Son, Warrington, PA (US); Zhibi Wang, Woodridge, IL (US); Michelle Perras, Montreal (CA); Anuj Sethi, Ottawa (CA); Taimoor Abbas, Sainte-Julie (CA); Achref Methenni, Montreal (CA); Samir Ferdi, Kirkland (CA); Guanzhou Wang, Brossard (CA); Saad Ahmad, Montreal (CA)

(73) Assignee: InterDigital Patent Holdings, Inc., Wilmington, DE (US)

(21) Appl. No.: 19/111,189

(22) PCT Filed: Sep. 25, 2023
(86) PCT No.: PCT/US2023/075005

§ 371 Date: Mar. 12, 2025

Related U.S. Application Data
(60) Provisional application No. 63/411,326, filed on Sep. 29, 2022.

(51) Int. Cl. H04W 64/00; H04W 8/00; H04W 76/14; H04W 88/04; H04W 92/18

(52) U.S. Cl. CPC H04W 64/00; H04W 8/005; H04W 76/14; H04W 88/04; H04W 92/18

(57) ABSTRACT

A wireless transmit/receiver unit (WTRU) is configured with PC5 Signaling by a ProSe layer and for ranging and sidelink (SL) positioning. The WTRU is further configured to initiate a connection setup for SL positioning with a relay WTRU when the target WTRU is out of coverage. The WTRU locates potential relay WTRUs having a known location within a network. The WTRU connects to one relay WTRU via SL positioning and receives from the relay WTRU a deferred mobile terminated location request or a periodic location request for the target WTRU location information. The WTRU may further receive a location request from an Access and Mobility Management Function (AMF) or a Location Management Function (LMF) in a network, wherein the AMF/LMF sends the location request to the target WTRU via the relay WTRU.

### CROSS REFERENCE TO RELATED APPLICATION

This application claims the benefit of U.S. Provisional Application No. 63/411,326, filed on Sep. 29, 2022, the entire contents of which are incorporated herein by reference.

### BACKGROUND

In current 5G systems (5GS), the location information of a wireless transmit/receive unit (WTRU) may be supported by a radio access technology (RAT) dependent method or a RAT independent method. The RAT dependent method needs the interaction between WTRU and 5GS and the RAT independent method relies on the information provided from WTRU. Therefore, there may be a limitation in 5G location services to when the WTRU is in the coverage of the 5GS.

There is a proposed work-around to extend coverage of WTRU in 5GS by using a proximity services relay (ProSe Relay). The connection from WTRU to the 5GS through ProSe Relay is called an indirect connection. The indirect connection may be triggered by the WTRU itself and not by network. Further, a 5GS may not trigger a location request to a WTRU that may be out of coverage until the WTRU goes back in coverage or connects with a ProSe Relay.

Another proposed work-around to enable location service for the WTRU out of coverage includes positioning using communications without traversing the network (with or without assistance from the eNB), known as PC5 based communication or using what is known as sidelink communication capabilities of LTE and in 5G for NR, i.e. SL positioning. When WTRU (here, WTRU1) is out of coverage, the WTRU1 may make SL positioning with another WTRU (here, WTRU2) which may be available for the air interface for LTE, as well as for 5G, called the Uu interface. In Uu based positioning, the WTRU1's location may be determined by the network using SL positioning between WTRU1 and WTRU2 and location information of WTRU2. WTRU2 may be called a located WTRU.

In this case, when a WTRU (here, target WTRU) may be out of coverage and if 5GS want to trigger location request to the target WTRU, the 5GS may contact several located WTRUs which may communicate with target WTRU. However, since the 5GS does not know the location of target WTRU, the selection of located WTRU may be based on last known information before the WTRU goes out of coverage. The last known location selection may not be successful in many cases, as the WTRU may not be reachable by the located WTRU because of the WTRU's mobility. The broadening of the WTRU's possible location for selection of a located WTRU based on last known information, may require more overhead like PC5 signaling from the located WTRU (e.g., out of range of the target WTRU) and maintaining of candidate located WTRU's list.

### SUMMARY

In a WTRU that supports PC5 Signaling that is supported by the ProSe layer, the WTRU may be provided with the capability of ranging and sidelink positioning. Ranging refers to the determination of the distance between two or more WTRUs and the direction and/or relative positioning of one WTRU with respect to another. A located WTRU refers to a WTRU where the location may be known or may be known using Uu based positioning by a 5GS. A located WTRU may be used to determine the location of another WTRU using sidelink positioning, where the WTRU is configured to initiate a connection setup with a relay WTRU when the WTRU is out of coverage for SL positioning. A location request known as a Deferred Mobile Terminated location request may request location information when WTRU is out of coverage using SL positioning with a located WTRU.

A target WTRU may support ProSe connection and SL positioning and/or SL positioning while the WTRU may be out of coverage. The WTRU may be configured to connect to the relay WTRU for SL positioning, e.g. L2 WTRU-to-network (also WTRU2NW, U2N or UE2NW) Relay WTRU, L3 WTRU2NW Relay WTRU with non-3G access interworking function (N3IWF). The location request may be sent from an Access and Mobility Management Function (AMF) to the target WTRU, the /F/ Location Management Function (LMF) sends location request to the target WTRU via relay WTRU. After the SL positioning, the location report of the target WTRU may be sent to the LMF and/or AMF via relay WTRU.

The location request from location service (LCS) client or the analytics function (AF) may include a deferred location request or a periodic location request. The deferred location and periodic location request types may request location information for the target WTRU even when the target WTRU is out of coverage. When the target WTRU receives the deferred location request with the indicated location request type, the target WTRU performs SL positioning with a discovered or located WTRU using provided configuration information. The target WTRU reports its location to the LMF and/or AMF by a location report from the located WTRU.

The AMF may trigger the location request, including a deferred location request, if the WTRU is out of coverage. Upon receipt by the target WTRU of the location request (with the indicated location request type), the target WTRU performs SL positioning with the discovered or located WTRU using the configured information. Further, the target WTRU may report its location to the LMF and/or AMF by the location report from the located WTRU. The LMF may determine a location result (for example, an absolute location of target WTRU based on the SL positioning data and the location of the located WTRU, and provide the location of target WTRU. The LMF may provide the determined location of the target WTRI, such as through the GMLC to the LCS Client or the AF of the network.

A WTRU may be configured to perform a method of operation within a network where it receives configuration information from a network associated with sidelink SL positioning and one or more trigger conditions. Once the first mentioned WTRU determines that the trigger condition(s) has (have) been satisfied, the WTRU may proceed to discover a second WTRU. The first WTRU may perform SL positioning with the second WTRU. The data that may be generated by the SL positioning may be used to determine the location of the first WTRU relative to the second WTRU. The first WTRU may then send at least a portion of the configuration information to the second WTRU. The configuration information may be included in a location report to be sent by the second WTRU to the network. The configuration information may include a location request identifier. The portion of the configuration information sent to the second WTRU may also include the location request identifier. The configuration information may be received from an LMF of the network, and the location request identifier may identify the LMF. The first configuration information may include a deferred location request from the LMF.

The first or target WTRU may be configured to determine that it is out of coverage. The WTRU may further send an identifier of the first WTRU to the second WTRU to be included in a location report to be sent by the second WTRU to the network. The first WTRU may discover one or more second WTRUs by sending a solicitation message and receiving an announcement message responding to the solicitation message.

A WTRU (e.g., a located WTRU) may be configured to perform a method of operation within a network where it discovers a second WTRU (e.g., a target WTRU) and performs SL positioning with the second WTRU and may establish a PC5 connection. The first mentioned WTRU may determine a location of the second WTRU relative to the first WTRU. The first WTRU may receive an identifier of the second WTRU and may further receive information identifying an LMF of a network. The first WTRU may send a location report to the network, wherein the location report comprises the identifier of the second WTRU and the information identifying the LMF of the network. The first WTRU may be further discover the second WTRU by receiving a solicitation message from the second WTRU and/or may send an announcement message to the second WTRU. The first WTRU may receive from the second WTRU as part of the configuration or otherwise a deferred location request identifying the LMF. The location report may be sent to an LMF and/or AMF of the network.

### BRIEF DESCRIPTION OF THE DRAWINGS

FIG. 1A is a system diagram illustrating an example communications system in which one or more disclosed embodiments may be implemented;

FIG. 1B is a system diagram illustrating an example of a wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of a reference model for a 5G/NextGen network.

FIG. 3 shows an example of a reference model for a 5G/NextGen network including location services.

FIG. 4 shows an example of a connection establishment with a WTRU-to-Network relay based on configuration.

FIG. 5 shows an example of a deferred Mobile Terminal Location Request (MT-LR) procedure for an out of coverage condition.

FIG. 6 shows an example of an MF triggered deferred MT-LR procedure for an out of coverage condition.

### DETAILED DESCRIPTION

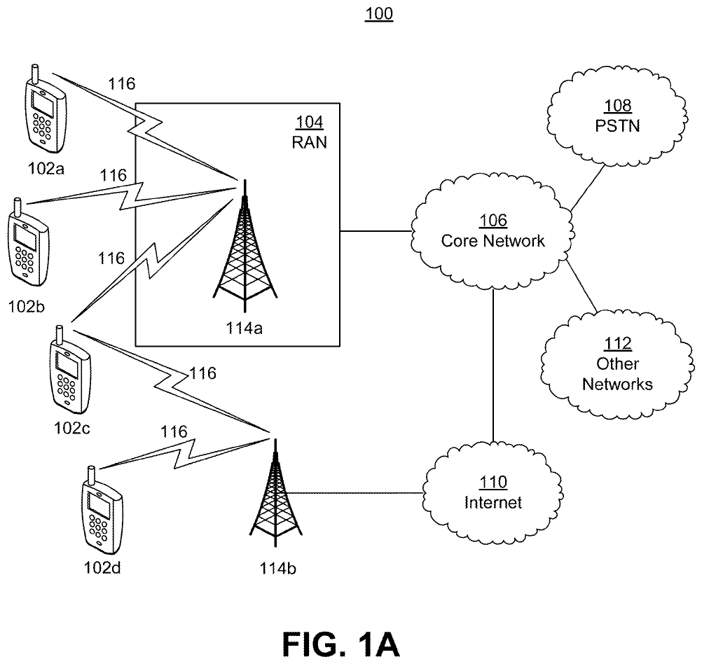

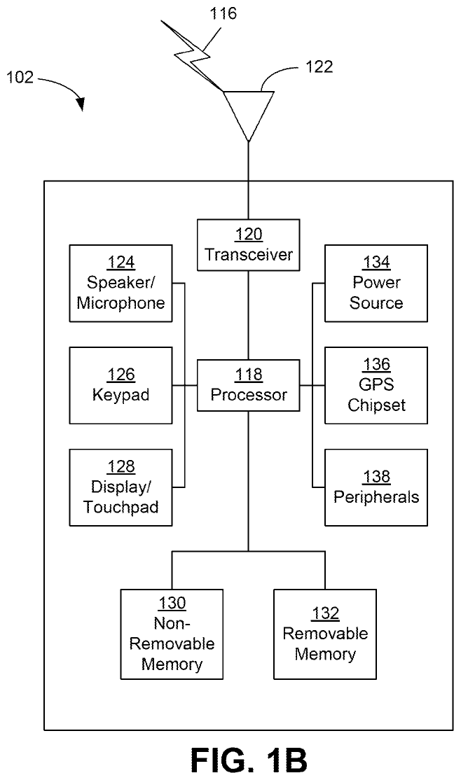

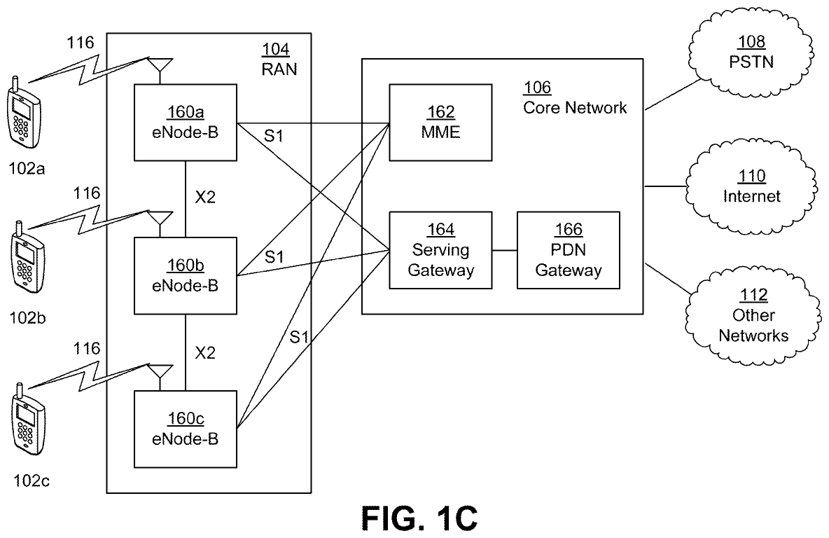

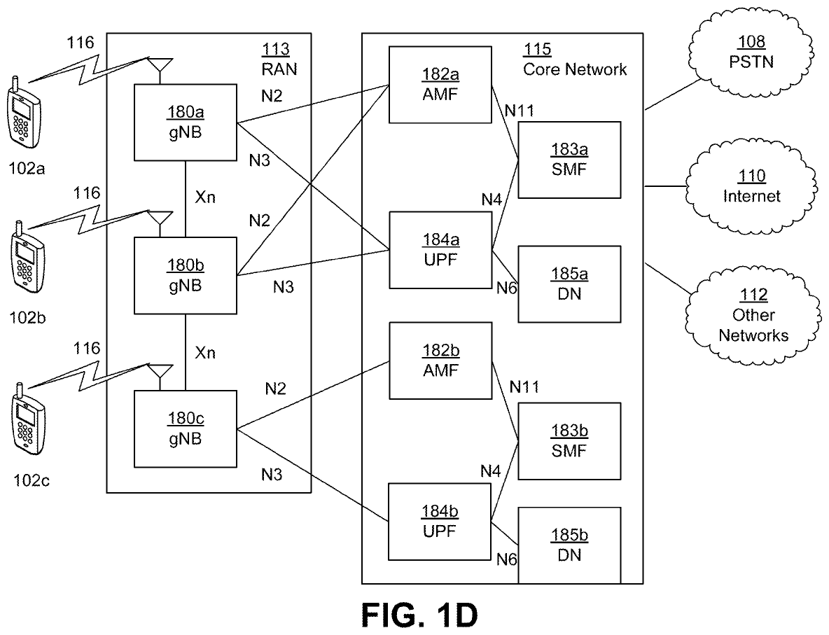

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable RAT.

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116 The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. One or more of the gNBs 180a, 108b may utilize beamforming to transmit signals to and/or receive signals from the gNBs 180a, 180b, 180c. Thus, the gNB 180a may use multiple antennas to transmit wireless signals to, and/or receive wireless signals from, the WTRU 102a. The gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. The OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards an AMF 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. The AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. Different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QOS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. The CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. The emulation devices may be used to test other devices and/or to simulate network and/or WTRU functions.

The emulation devices may be designed to implement one or more tests of other devices in a lab environment and/or in an operator network environment. The one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. The emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

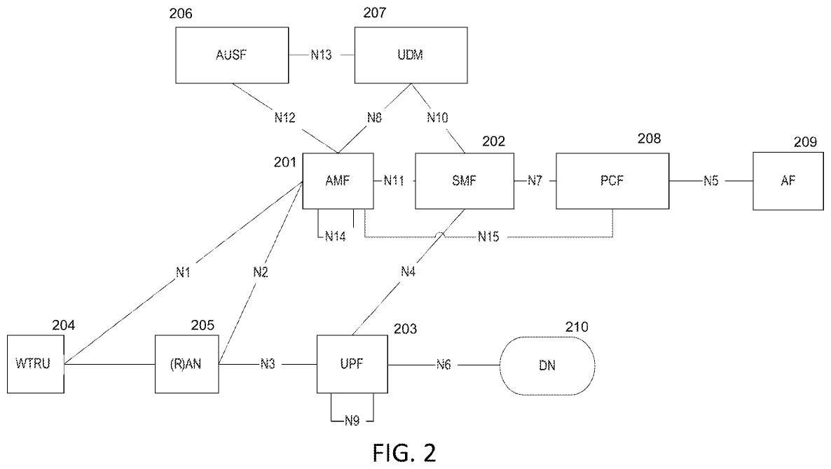

In FIG. 2 there is shown a reference model for a potential architecture of a 5G or NextGen network. RAN here refers to a radio access network based on the 5G RAT or Evolved E-UTRA that connects to the NextGen core network. The AMF 201 may include the functionalities of registration management, connection management, reachability management, mobility management, etc. The session management function (SMF) 202 may include the functionalities of session management (including session establishment, modify and release), WTRU IP address allocation, selection and control of UP function, etc. Further, the user plane function (UPF) 203 may include the functionalities of packet routing & forwarding, packet inspection, traffic usage reporting, etc. The UPF 203 may interface directly with Data Networks (DN) 210. The AMF 201 and the SMF 202 may interface with the Authentication Server Function (AUSF) 206 and the Unified Data Management (UDM) 207. The SMF may interface with the Policy Control Function (PCF) 208 and in turn to the Application Function (AF) 209. The AMF 201 may directly interface with the PCF 208 (such as via interface N15).

5G location service provides functionality for positioning information of a WTRU 204. The positioning of a WTRU 204 may be supported by RAT dependent position method, which rely on 3GPP RAT measurements obtained by a target WTRU and/or on measurement obtained by an Access Network of 3GPP RAT signals transmitted by a target WTRU (see, e.g., (R)AN 205). The WTRU 204 and the (R)AN 205 may interface directly with the AMF 201. Positioning of a WTRU 204 may also be supported by RAT independent position methods which may rely on non-RAT measurements obtained by a WTRU 204 and/or on other information. Location information for one or multiple target WTRUs may be requested by and reported to an LCS client or the AF 209 within or external to a 3GPP operator network, or a control plane network function (NF) within 3GPP system. For location request from LCS client or an AF (209), privacy verification of the target WTRU 204 may be enabled to check whether it is allowed to acquire the WTRU location information.

There may be several different types of location request supported, including mobile terminated location request (MT-LR), which for an LCS client or AF 209 sends a location request to the 5G Network for the location of a target WTRU 204. Another supported location request may be mobile originated location request (MO-LR), where a WTRU 204 sends a request to the 5G Network for location related information for the WTRU. A supported immediate location request functions as an LCS client or AF 209 sends or instigates a location request for a target WTRU(s) and expects to receive a response containing location information for the target WTRU(s) within a short time period. It may be used for an MT-LR or an MO-LR. Another supported location request format may be deferred location request whereby an LCS client or AF sends a location request to the 5G network for a target WTRU(s) and expects to receive a response when an indicated event occurred for the target WTRU at some future time. It may be used for an MT-LR.

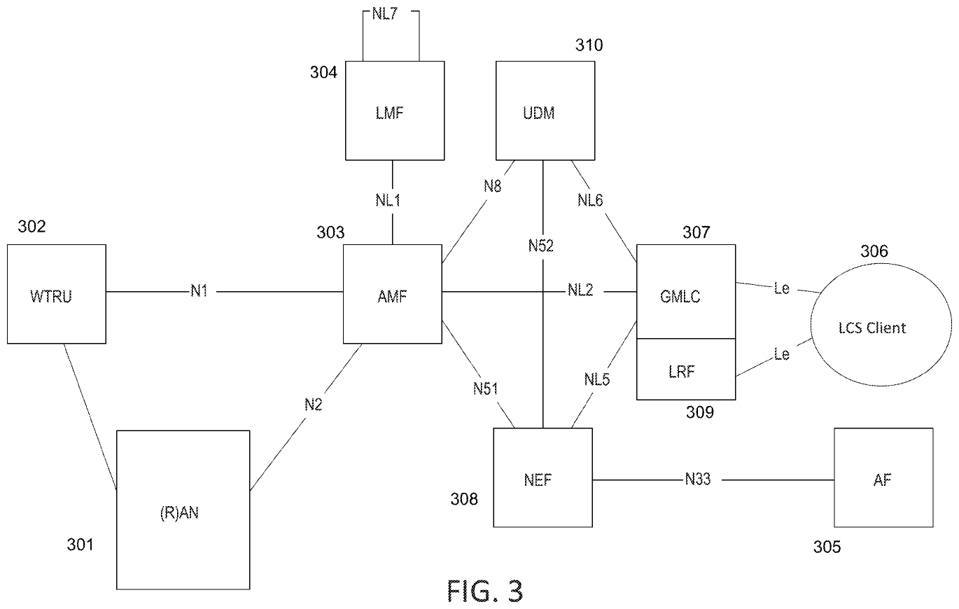

In FIG. 3 there is shown a reference model for a 5G/NextGen Network for location service whereby (R)AN 301 represents NG-RAN, trusted non-3GPP access or untrusted non-3GPP access. The access network may be involved in the handling of various positioning procedures including positioning of a target WTRU 302, provision of location related information not associated with a particular target WTRU 302 and transfer of positioning messages between an AMF 303 or LMF 304 and a target WTRU 302. AFs 305 and NFs may access LCS services from a Gateway Mobile Location Centre (GMLC) 307 in the same 3GPP operator network. LCS clients 306 may access LCS services from a GMLC 307 and External AF 305 may access LCS service from an NEF 308. The AMF 303, NEF 308 and GMLC 307 may also interface with the UDM 310.

GMLC 307 handles the request from external LCS client 306, AF 305, via NEF 308 if the AF 305 may be an external AF, and forward location request to the proper NF. Location Retrieval Function (LRF) 309 may be responsible for retrieving or validating location information and may be collocated with an GMLC 307 or separate. LMF 304 manages the overall co-ordination and scheduling of resources required for the location of a WTRU 302 that may be registered with or accessing a 5G core network (5GCN). It may calculate or verify final location related information and achieved accuracy.

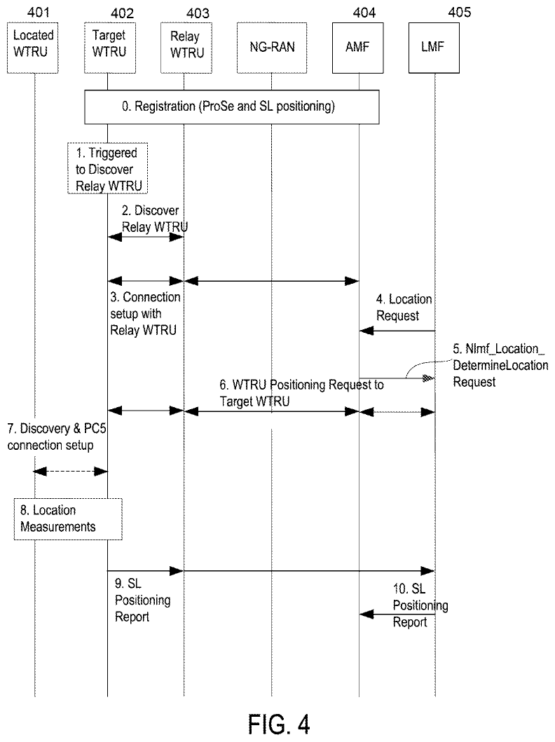

FIG. 4 shows an a procedure for connecting a WTRU-to-network (WTRU2NW) relay (which may also be called a UE2NW relay) based on configured information for a located WTRU 401. At Step 0, if a target WTRU 402 may be capable of SL positioning and/or the WTRU 402 may be capable of SL positioning while out of coverage, the WTRU 402 identifies this capability during registration. In response, the target WTRU 402 will be provisioned with parameters to be used for ProSe connection setup and SL positioning that may include target WTRU ID information to be used for discovery, PC5 link setup for SL positioning application and ProSe service information for the SL positioning application. The WTRU 402 may also be configured with information about the relay WTRUs 403 with the Relay Service code (RSC), which may also indicate its support handling SL positioning message or RSC with indication whether relay supports handling SL positioning message.

The target WTRU 402 may be configured to connect a WTRU2NW relay when the target WTRU 402 enters out of coverage and find relay WTRU 403 supporting a WTRU2NW relay based on WTRU's capability supporting ProSe connection and SL positioning and/or SL positioning while out of coverage. If Network does not want to enforce WTRU's availability via relay while WTRU 402 may be out of coverage, network may direct the WTRU 402 to turn off this configuration.

Alternatively or additionally, 5GS may identify the potential area which the target WTRU 402 may be out of coverage based on mobility pattern of the target WTRU 402 and analytic information related thereto. 5GS may provide several designated WTRU(s) to provide assistance as relay or located WTRU 401 within the potential area of the target WTRU 402. The designated WTRUs 401 may be selected based on mobility pattern of the WTRUs including mobility pattern of target WTRU 402 and potential assisting WTRUs and analytic information of those WTRUs. The mobility pattern information may include information related to how often the WTRU 402 approached out of coverage area for an individual area, how long it remained out of coverage when it entered, and how quickly the WTRU 402 moved around those area.

The 5GS may provide location information such as tracking area, cell ID nearby, potential out of coverage area and/or an assisting WTRU list (e.g., a list of potential assistance WTRUs 401) and relating information (e.g., RSC or WTRU ID information) to be used for discovery. The 5GS may provide (separately or in addition to the above) a list of potential assistance WTRUs 401 based on registration area of the target WTRU 402. The 5GS may update list of potential assistance WTRUs 401 when the target WTRU 402 makes mobility registration based on the target WTRU's registration area.

Even though the target WTRU 402 may be configured to connect to a relay WTRUs 403, the target WTRU 402 may not perform connecting to a relay WTRU 403, while the target WTRU 402 may be out of coverage (e.g., because of low battery or user's choice) and the WTRU may provide this information to the network (if available).

In procedure Step 1, when the target WTRU 402 detects it may be out of coverage, it may initiate discovery of the relay WTRU 403 as configured in Step 0 or based on any pending request from LCS client, AF, or any NF to report its location when it enters out of coverage. The target WTRU 402 alternatively or separately may try to discover an assisting WTRU 401 even before the WTRU 402 may be out of coverage, if the WTRU 402 approaches a potential area in which target WTRU 402 may be out of coverage. This alternative or separate process may be configured at Step 0 in order to reduce time out of coverage.

In Step 2, based on the configuration information from Step 0, the target WTRU 402 may perform a discovery procedure by monitoring announcement messages from potential relay WTRUs 403 or may initiate a solicitation message in order to find a relay WTRU 403. In Step 3, the target WTRU 402 attempts to make a connection setup with the relay WTRU 403. Further, the target WTRU 402 may perform registration procedure with the AMF 404 via relay WTRU 403. In Step 4, the AMF 404 may receive location request for the target WTRU 402 or may be triggered to initiate location request for the target WTRU 402. Step 5 may be a selection process by the AMF 404 to identify an LMF 405 to handle positioning of target WTRU 402. The AMF 404 sends the LMF 405 a location request for the target WTRU 402.

In Step 6, the LMF 405 and the target WTRU 402 communicate to exchange capabilities for SL positioning and/or Uu positioning, to inform any assistant information for positioning, and to send a positioning request to the target WTRU 402. Once performed, in Step 7, the target WTRU 402 attempts to discover a located WTRU 401 by monitoring for announcement messages from any located WTRU 401 or by sending solicitation message to find any located WTRU 401 using the information in Step 0. When the target WTRU 402 discovers a located WTRU 401, the target WTRU 402 establishes a PC5 connection with the located WTRU 402. When relay WTRU 403 is capable of and authorized to work as a located WTRU 401 that may be known to the target WTRU 402, the target WTRU 402 may use the relay WTRU 403 as a located WTRU 401

In Step 8, the target WTRU 402 and the located WTRU 401 perform SL positioning to measure location of the target WTRU 402, for example, relative to one another. In Step 9, the target WTRU 402 may send the LMF 405 a location report that may include the SL positioning result between target WTRU 402 and located WTRU 401 and information about the located WTRU 401.

After receiving a location report, in Step 10 the LMF 405 may determine the location of the target WTRU 402 using the SL positioning result and the location of the located WTRU 401. If needed, the LMF 405 may perform a Uu positioning procedure with the located WTRU 401 to determine the location of the target WTRU 402. The LMF 405 may send the determined location information of the target WTRU 402 to the AMF 404. The LMF 405 may also include the information about located WTRU 401 in the location report.

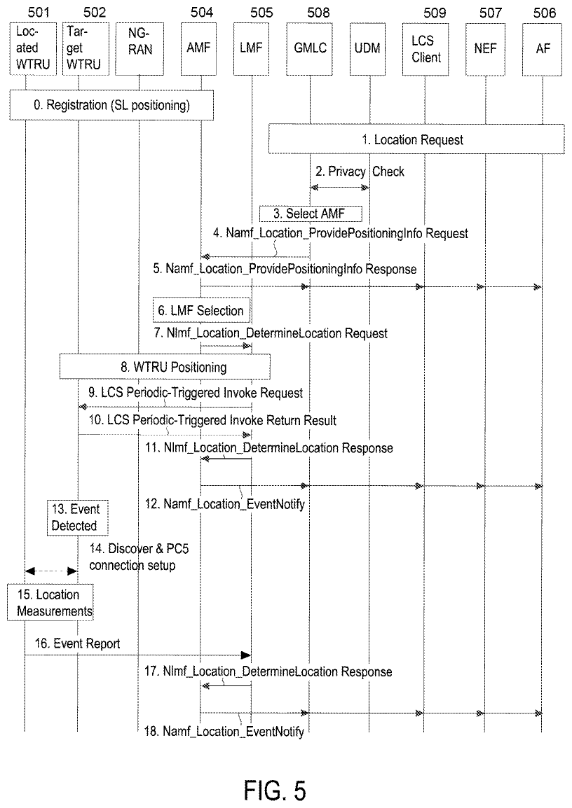

In FIG. 5, there is shown a procedure for a deferred 5G MT-LR request for the target WTRU 502 that originates from an AF 506 or LCS client 509. In Step 0, if a WTRU 502 is capable of SL positioning and/or the WTRU 502 may be capable of SL positioning while out of coverage, the WTRU 502 indicates that capability during registration. The WTRU 502 will be provisioned with parameters to be used for SL positioning. The parameters may include a target WTRU ID information to be used for discovery, PC5 link setup for SL positioning application and ProSe service information for the SL positioning application. Separately or in addition to the above, the WTRU 502 may be configured with information to be used to discover a located WTRU 501. This configuration information may include one or more discovery codes or application codes of located WTRU 502, filter information to detect located WTRU 502, or a list of located WTRU's ID. This configuration information may include one or more relay service code (RSC) to discover WTRU2NW relay WTRU with or without SL positioning capability which is capable of forwarding SL positioning message between an WTRU to the network (NW). The configuration information may also include the RSC for the located WTRU 502, when the located WTRU 501 may work as a WTRU2NW relay WTRU. This information may be combined with validation conditions, such as time periods and locations (e.g. cell or TA level) that may be provided together.

After receipt of the configuration information, in Step 1 an LCS client 509 or an AF 506 (e.g., via NEF 507, when the AF 506 may be outside of operator domain) may request 5GCN to report location information of the target WTRU 502 and the location request may include a request type that is to report the location information of the target WTRU 502 when it enters out of coverage. The location request may also include a request to report the location information of the target WTRU 502 periodically with a time interval. A periodic location report may also be provided that includes its location (even the target WTRU 502 may be out of coverage) by using SL positioning and located WTRU 501 (if available).

In Step 2, after receiving a location request, GMLC 508 may check privacy setting of the target WTRU 502 and whether the target WTRU 502 may be permitted to inform its location with requesting AF 506 or LCS client 509. The target WTRU's 502 privacy setting may be different for each application. The privacy settings may be different for an in-coverage case and an out of coverage case. In Step 3, the GMLC 508 selects the serving AMF 504 of the target WTRU 502 for sending the received location request. In Step 4, the GMLC 508 sends the AMF 504 a signaling message to forward the received location request. In Step 5, when the AMF 504 receives the location request, it may be acknowledged to the GMLC 508. After receiving the acknowledgement from AMF 504, the GMLC 508 may send a further acknowledgement to the AF 506 or the LCS client 509 that sent the location request. In Step 6, the AMF 504 selects an LMF 505 to handle positioning of target WTRU 502.

In Step 7, the AMF 504 may send the LMF 505 a location request for the target WTRU 502 that includes the request type received from a GMLC 508. For a deferred location request, the AMF 504 may include a triggering condition indicating that it should report its location information when the WTRU 502 enters an out of coverage area by connecting through the WTRU2NW relay WTRU or via the located WTRU 501. For the periodic location request, it may be configured or indicated that the target WTRU 502 needs to report its location even when the target WTRU 502 may be out of coverage by connecting through WTRU2NW relay WTRU or via the located WTRU 501. In Step 8, after receiving the location request, the LMF 505 may communicate with the target WTRU 502 to exchange capability information for the SL positioning and/or the Uu positioning and any other assistance information for positioning.

The target WTRU 502 may receive configuration information that, for example, is associated with SL position. In some examples, the target WTR 502 may receive the configuration information from the LMF 505. The configuration information may include one or more out of coverage trigger conditions. For example, in Step 9, the LMF 505 may send the target WTRU 502 a deferred location request with a location request type that includes a deferred location request type with triggering conditions or a periodic location request type. In order to identify the location request, the LMF 505 may include identifier of the location request, such as LOC Event Identifier. By comparing the LOC Event Identifier and the identifier of the target WTRU 502, the LMF 505 may verify whether the location report relates to the sent location request. In some examples, the LOC Event Identifier may identify the LMF 505. In Step 10, after receiving the deferred location request, the target WTRU 502 may respond to the LMF 505. The target WTRU 502 may further start monitoring whether the triggering condition(s) are met.

In Step 11, after receiving the acknowledgement from the target WTRU 502, the LMF 505 may inform the AMF 504 that the target WTRU 502 successfully received the location request. In Step 12, the AMF 504 may inform the GMLC 508 that the location request may be successfully sent to the target WTRU 502. Further, the GMLC 508 may inform the requesting AF 506 or LCS client 509 that the location request was successfully sent to the target WTRU 502.

The target WTRU 502 may determine that the out of coverage trigger condition has been satisfied, and in response, may perform SL positioning with a located WTRU based on the trigger condition being satisfied. For example, in Step 13, if the target WTRU 502 finds it may be out of coverage, as indicated in the triggering conditions, the target WTRU 502 tries to discover one or more located WTRUs 501, for example, by monitoring any announcement messages from any located WTRUs 501 or by sending solicitation message to find any located WTRU 501 (e.g., using the information in Step 0). In Step 14, when the target WTRU 502 discovers a located WTRU 501, the target WTRU 502 establish a PC5 connection with the located WTRU 501. In Step 15, the target WTRU 502 and the located WTRU 501 perform SL positioning to measure the location of the target WTRU 502. For example, the located WTRU 501 may be configured to determine the location of the target WTRU 502 via the SL position method. The target WTRU 502 may send at least a portion of the configuration information (e.g., LMF information) to the located WTRU 501 to be included in a location report to be sent by the located WTRU 501 to the network. For example, the target WTRU 502 may inform the located WTRU 502 of LMF information. The located WTRU 502 may send a deferred location request to the target WTRU 502. The target WTRU 502 may inform the located WTRU 501 of LOC Event identifier and target WTRU's 502 identifier, and the located WTRU 501 may include the LOC Event identifier and/or target WTRU's 502 identifier in location report that is sent to the network. In Step 16, the located WTRU 501 sends the LMF 505 a location report that includes SL positioning results between the target WTRU 502 and the located WTRU 501. The location report may also include the LOC Event identifier and the target WTRU's 502 identifier as received in Step 15.

In Step 17, after receiving the location report from the located WTRU 501, the LMF 505 may determine the location of the target WTRU 502 using the SL positioning result and the location of the located WTRU 501. If needed, the LMF 505 may perform a Uu positioning procedure with the located WTRU 501 to determine the location of the target WTRU 502. The LMF 505 may also send the determined location information of the target WTRU 502 to the AMF 504. The LMF 505 may include the information about located WTRU 501 in the location report. In Step 18, after receiving the location report of the target WTRU 502 from the LMF 505, the AMF 504 may send the location report to the GMLC 508. The GMLC 508 sends the location report of the target WTRU 502 to the requesting AF 506 or the LCS client 509.

Alternatively or additionally, the 5GS may be aware of the potential area where the target WTRU 502 may be out of coverage based on target WTRU's 502 mobility pattern and analytic information on the target WTRU 502. For the potential out of coverage area, 5GS may install several designated WTRU(s) to provide assistance to the located WTRU 501. The 5GS may provide location information such as a tracking area, cell ID, nearby potential out of coverage area and/or an assisting WTRU's list. Related information, such as a discovery code and/or WTRU ID information to be used for discovery, such as in Step 0, Step 7, Step 8, and Step 9. If configured, in Step 13, the target WTRU 502 may be triggered to discover the configured located WTRU 501 when the target WTRU 502 detects that it may be close to the potential out of coverage area.

After the target WTRU 502 finds it may be out of coverage in Step 13, when the target WTRU 502 discovers the WTRU2NW relay WTRU, the target WTRU 502 connects to the relay WTRU. It may perform SL positioning with the WTRU2NW relay if the relay WTRU supports the located WTRU 501 or with any located WTRU 501 discovered in Step 15. Further, in Step 16, the target WTRU 502 may report the location report through the WTRU2NW relay to the LMF 505.

After the target WTRU 502 finds it may be out of coverage in Step 13, the target WTRU 502 may perform other procedures to report its location to the NW, for example, utilizing a RAT independent positioning method for positioning and/or to trigger a MO-LR location request.

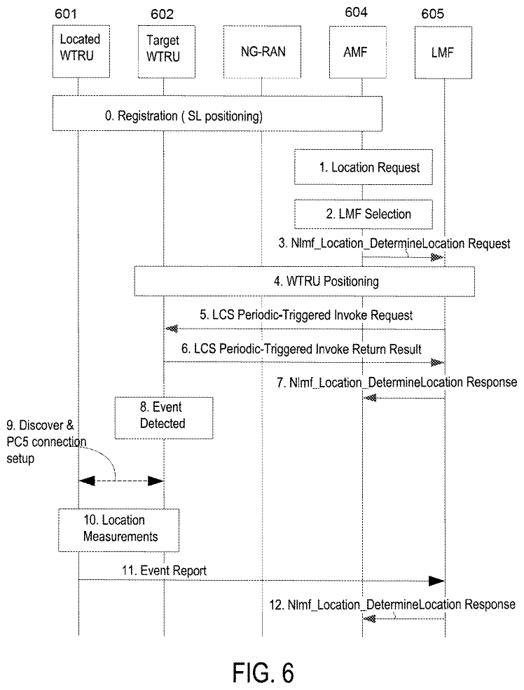

In FIG. 6, there is shown a procedure for a deferred 5G MT-LR request for the target WTRU 602 by AMF 604 or LMF 605. In order to handle location request from an AF or the LCS client, the AMF 604 or the LMF 605 may need to keep tracking location of the target WTRU 502. In order maintain tracking, the AMF 604 or the LMF 605 may trigger a location request to the target WTRU 502 to report its location through the located WTRUs 601, when the WTRU 602 may be out of coverage but the discovered or located WTRUs 501 may be nearby. The triggering condition may include that the WTRU 602 should report its location when the located WTRU 501 reachable to WTRU 502 may change because of WTRU's mobility or otherwise.

In Step 0 of FIG. 6, if a WTRU 602 is capable of SL positioning and/or SL positioning while out of coverage, the WTRU 602 indicates that capability during registration. The WTRU 602 will be provisioned with parameters to be used for SL positioning. The parameters may include a target WTRU ID information to be used for discovery, a PC5 link setup for the SL positioning application and ProSe service information for the SL positioning application. The WTRU 602 may be configured with information to be used to discover the located WTRU 601. A discovery code or application code, Prose L2 ID of located WTRU 601, filter information to detect located WTRU 601, and/or a list of located WTRU's ID may be provided. This configuration information may include one or more relay service code (RSC) functions to discover the WTRU2NW relay WTRU with or without SL positioning capability, which is capable of forwarding SL positioning message between the WTRU and the NW. This information may include RSC of located WTRU 601, when the located WTRU 601 will work as a WTRU2NW relay WTRU. The information may be combined with validation conditions, such as time periods and location (e.g. cell or TA level).

In Step 1, the AMF 604 may be triggered to initiate the location request for the target WTRU 602, for example, after detecting that the target WTRU 602 may be capable of SL positioning and/or SL positioning while out of coverage. The AMF 604 may initiate deferred location request for the target WTRU 602 with triggering condition to report its location information based on SL positioning directly, by connecting through the WTRU2NW relay WTRU, or via located WTRU 601. The triggering condition of location report may include the situation, when the WTRU 502 may be out of coverage, and discover a located WTRU 601 or a WTRU2NW relay WTRU, when WTRU connected to another located WTRU 601 or when the WTRU may be disconnected from an old located WTRU and connected to new located WTRU 601, or when the WTRU move to another a WTRU2NW relay WTRU while it is out of coverage. In Step 2, the AMF 604 may select an LMF 605 to send a deferred location request to the target WTRU 602. In Step 3, the AMF 604 may send a deferred location request for the target WTRU 602 to the selected LMF 605. In Step 4, after receiving the request, the LMF 605 may communicate with the target WTRU 602 to exchange capabilities for SL positioning and/or Uu positioning and any assistant information for positioning.

In Step 5, the LMF 605 may send a target WTRU 602 a deferred location request with a triggering condition. As indicated by the AMF 604, the triggering condition may include the situation when the WTRU 602 may be out of coverage and discover a located WTRU 601 or a WTRU2NW relay WTRU, when the WTRU may be connected to another located WTRU 61, or when the WTRU 602 may be disconnected from the old located WTRU and connected to a new located WTRU 601, or when the WTRU 602 moves to another a WTRU2NW relay WTRU while it is out of coverage. In order to identify the location request, the LMF 605 may include an identifier of the location request such as LOC Event Identifier. By comparing the LOC Event identifier and the identifier of the target WTRU 602, the LMF 605 may verify whether the location report may be relating to the sent location request.

At Step 6, after receiving the deferred location request including triggering conditions, the target WTRU 602 may respond to the LMF 605. The target WTRU 602 may start monitoring whether triggering conditions are met. In Step 7, after receiving a response from the target WTRU 602, the LMF 605 may inform the AMF 604 that deferred location request was successfully sent to the target WTRU 602. In Step 8, when the target WTRU 602 finds it may be out of coverage, as indicated in the triggering conditions, the target WTRU 602 tries to discover the located WTRU 601 by monitoring any announcement messages from any located WTRU 601 or by sending solicitation message to find one or more located WTRUs 601 using the information in Step 0. In Step 9, when the target WTRU 602 discovers a located WTRU 601, the target WTRU 602 establishes a PC5 connection with the located WTRU 601.

In Step 10, the target WTRU 602 and the located WTRU 601 perform SL positioning to measure location of the target WTRU 602, for example, relative to one another. The target WTRU 602 may inform the located WTRU 601 of the LMF 605, which sends a deferred location request to the target WTRU 602 in a location report. The target WTRU 602 may inform the located WTRU 601 of the LOC Event identifier and target WTRU's 602 identifier, which may be included in the location report. In Step 11, the located WTRU 601 sends the LMF 605 a location report including the SL positioning result between the target WTRU 602 and the located WTRU 601. The location report may also include the LOC Event identifier and the target WTRU's 602 identifier, as received in Step 10.

In Step 12, after receiving the location report from the located WTRU 601, the LMF 605 may determine the location of the target WTRU 602 using SL positioning result and location of the located WTRU 601. If needed, the LMF 605 may perform Uu positioning procedure with the located WTRU 601 to determine the location of the target WTRU 602. LMF 605 may send the determined location information of the target WTRU 602 to the AMF 604. The LMF 605 may include the information about located WTRU 601 in the location report.

Later, the AMF 604 and the LMF 605 may use the located WTRU 601 to send location request to the target WTRU 602 or to request location information of the target WTRU 602 by using SL positioning.

After the target WTRU 602 finds that it may be out of coverage in Step 13, when the target WTRU 602 discovers the WTRU2NW relay WTRU, the target WTRU 602 may connect to the relay WTRU. It may perform SL positioning with the WTRU2NW relay, if the relay WTRU supports the located WTRU 601 or with any located WTRU 601 discovered in Step 15. Further, in Step 16, the target WTRU 602 may report the location report through the WTRU2NW relay to the LMF 605. The target WTRU 602 finds it may be out of coverage in Step 13, the target WTRU 602 may perform other procedures to report its location to the NW, for example, utilizing a RAT independent positioning method for positioning and/or to trigger a MO-LR location request.

Alternatively or additionally, the 5GS determine the potential area where the target WTRU 602 may be out of coverage based on WTRU's mobility pattern and analytic information on the target WTRU 602. For the determined out of coverage area, the 5GS may install several designated WTRU(s) to provide assistance as located WTRU 601. 5GS may provide location information, such as a tracking area, cell ID's near by the potential out of coverage area and/or assisting WTRU's list and relating information such as discovery code and/or WTRU ID information to be used for discovery in Step 0, Step 3, Step 4, and/or Step 5. If configured, in Step 8, the target WTRU 602 may trigger discovery of the configured located WTRU 601 when the target WTRU 602 detects that may be close to the potential out of coverage area.

After receiving a location request (periodic or based on out of coverage) with the parameters for detecting located WTRU's or Relay WTRU's, the target WTRU 602 may keep an updated list of located WTRU's /Relay WTRU's. The updated list may be combined with valid time period and area information with consideration of discovery result and at the time of event detection. Further, the target WTRU 602 may use the already built up information to connect to located WTRU/Relay WTRU to send back location reports to the network. This information may be reported to the 5GS and be used to calculate its mobility pattern or analytic information with potential assisting WTRU's list.

When the target WTRU 602 supports ProSe connection and SL positioning and/or SL positioning while the WTRU may be out of coverage, the WTRU 602 may be configured to connect to the relay WTRU for SL positioning, e.g. L2 WTRU2NW Relay WTRU, L3 WTRU2NW Relay WTRU with N3IWF. In embodiments, when the location request needs to be sent from the AMF 604 to the target WTRU 602, the AMF 604/LMF 605 sends location request to the target WTRU 601 via relay WTRU. After SL positioning, the location report of the target WTRU 602 may be sent to the LMF 605 and AMF 604 via relay WTRU.

Based on the forgoing, the location request from LCS client or AF may include a deferred location request or a periodic location request, which request location information of the target WTRU 602 even when the target WTRU 602 may be out of coverage. When the target WTRU receives the deferred location with the indicated location request type, the target WTRU performs SL positioning with the discovered or located WTRU using the configured information. The target WTRU reports its location to the LMF and the AMF by the location report from the located WTRU.

If a target WTRU supports SL positioning and/or SL positioning while the WTRU may be out of coverage, the AMF may trigger the location request, which may include a deferred location request, which requests location information of the target WTRU when the target WTRU may be out of coverage. When the target WTRU receives the deferred location request with the indicated location request type, the target WTRU performs SL positioning with the discovered or located WTRU using the configured information. The target WTRU reports its location to the LMF and AMF by the location report from the located WTRU.

A target or first WTRU may be configured with PC5 Signaling by a ProSe layer and for ranging and sidelink (SL) positioning. The target WTRU may be further configured to or perform a method of operation to initiate a connection setup for SL positioning with a relay WTRU when the target WTRU is out of coverage; connect to the relay WTRU via SL positioning; and thereafter receive from the network via the relay WTRU a deferred mobile terminated location request or a periodic location request for target WTRU location information. The target WTRU may, for example, prior to the SL positioning setup, locate potential relay WTRUs having a known location within a network. The relay WTRUs may be of a number of types, including an L2 WTRU2NW Relay WTRU or an L3 WTRU2NW Relay WTRU with N3IWF. The target WTRU may further receive a location request from an AMF or an LMF in a network, wherein the AMF/LMF sends the location request to the target WTRU via the relay WTRU. The target WTRU may be further configured to send a location report to the LMF or AMF via the relay WTRU.

A target or first WTRU may be configured to perform a method of operation within a network where the target WTRU receives configuration information from a network associated with sidelink SL positioning and one or more trigger conditions. Once the target WTRU determines that one or more trigger condition(s) has (have) been satisfied, the WTRU may proceed to discover or locate a second WTRU. The target WTRU may perform SL positioning with the located or second WTRU. The SL positioning data may be used to determine the location of the target WTRU, for example, relative to the located WTRU. The target WTRU may then send at least a portion of the configuration information to the located WTRU that may be included in a location report to be sent by the located WTRU to the network. The configuration information may include a location request identifier. The portion of the configuration information sent to the located WTRU may also include the location request identifier. The configuration information may be received from an LMF of the network, and the location request identifier may identify the LMF. The target configuration information may include a deferred location request from the LMF.

A target or first WTRU may be configured to determine that it is out of coverage. The target WTRU may further send an identifier for the target WTRU to the located WTRU to be included in a location report to be sent by the located WTRU to the network. The target WTRU may discover one or more located WTRUs by sending a solicitation message and receiving an announcement message responding to the solicitation message. The LMF may determine a location result (for example, an absolute location of Target WTRU based on the SL positioning and the location of the located WTRU), and may provide the location of target WTRU. The LMF may provide the determined location of the target WTRI, such as through the GMLC to the LCS Client or AF of the network.

In embodiments, the first WTRU may be as located WTRU and may be configured to perform a method of operation within a network where it discovers a second or target WTRU. The first and second WTRUs may perform SL positioning and may establish a PC5 connection. The first mentioned WTRU may determine a location of the second WTRU relative to the first WTRU. The first WTRU may receive an identifier of the second WTRU and may further receive information identifying an LMF of a network. The first WTRU may send a location report to the network, wherein the location report comprises the identifier of the second WTRU and the information identifying the LMF of the network. The first WTRU may be further discover the second WTRU by receiving a solicitation message from the second WTRU and/or may send an announcement message to the second WTRU. The first WTRU may receive from the second WTRU as part of the configuration or otherwise a deferred location request identifying the LMF. The location report may be sent to an LMF and/or AMF of the network.

What is claimed is:

1. A first wireless transmit/receive unit (WTRU) comprising:
a processor configured to:
receive configuration information from a network, wherein the configuration information is associated with sidelink (SL) positioning and comprises a trigger condition;
determine that the trigger condition has been satisfied;
determine that the first WTRU is in an out of coverage condition;
discover a second WTRU;
perform SL positioning with the second WTRU based on the trigger condition being satisfied, wherein the SL positioning is used to determine the location of the first WTRU relative to the second WTRU; and
send at least a portion of the configuration information to the second WTRU.

2. The first WTRU of claim 1, wherein the configuration information comprises a location request identifier, and wherein the at least the portion of the configuration information sent to the second WTRU comprises the location request identifier.

3. The first WTRU of claim 2, wherein the configuration information is received from a location management function (LMF) of the network, and wherein the location request identifier identifies the LMF.

4. The first WTRU of claim 1, wherein the configuration information comprises a deferred location request that is received from a location management function (LMF) of the network.

5. (canceled)

6. The first WTRU of claim 1, wherein the processor is further configured to send an identifier of the first WTRU to the second WTRU.

7. The first WTRU of claim 1, wherein the processor is further configured to discover the second WTRU by sending a solicitation message and receiving an announcement message responding to the solicitation message.

8. A method performed by a first wireless transmit/receive unit (WTRU), the method comprising:
receiving configuration information from a network, wherein the configuration information is associated with sidelink (SL) positioning and comprises a trigger condition;
determining that the trigger condition has been satisfied;
determining that the first WTRU is in an out of coverage condition;
discovering a second WTRU;
performing SL positioning with the second WTRU based on the trigger condition being satisfied and determining the location of the first WTRU relative to the second WTRU based on the SL positioning; and
sending at least a portion of the configuration information to the second WTRU.

9. The method of claim 8, wherein the configuration information comprises a location request identifier, and wherein the at least the portion of the configuration information sent to the second WTRU comprises the location request identifier.

10. The method of claim 9, further comprising receiving the configuration information from a location management function (LMF) of the network, and wherein the location request identifier identifies the LMF.

11. The method of claim 8, wherein the configuration information comprises a deferred location request that is received from a location management function (LMF) of the network.

12. (canceled)

13. The method of claim 8, further comprising sending an identifier of the first WTRU to the second WTRU.

14. The method of claim further comprising discovering the second WTRU by sending a solicitation message and receiving an announcement message responding to the solicitation message.

15. A first wireless transmit/receive unit (WTRU) comprising:
a processor configured to:
discover a second WTRU, wherein the second WTRU is in an out of coverage condition;
perform SL positioning with the second WTRU;
determine a relative location of the second WTRU to the first WTRU;
receive an identifier of the second WTRU and information identifying a location management function (LMF) of a network; and
send a location report to the network, wherein the location report comprises the identifier of the second WTRU and the information identifying the LMF of the network.

16. The first WTRU of claim 15, wherein the processor is further configured to establish a PC5 connection with the second WTRU.

17. The first WTRU of claim 15, wherein discovering the second WTRU comprises receiving a solicitation message from the second WTRU

18. The first WTRU of claim 15, wherein discovering the second WTRU comprises sending an announcement message to the second WTRU.

19. The first WTRU of claim 15, wherein the processor is further configured to receive, from the second WTRU, a deferred location request.

20. The first WTRU of claim 15, wherein the location report is sent to one or more of the LMF and the access and mobility management function (AMF) of the network.
